(19) United States
(12) Patent Application Publication
(10) Pub. No.: US 2010/0068350 A1
(43) Pub. Date: Mar. 18, 2010

(54) Pullulan Films and Their Use in Edible Packaging

(75) Inventors: Shiji SHEN, Forsyth, IL (US); Andrew HOFFMAN, Mount Zion, IL (US); Michael D. HARRISON, Decatur, IL (US); Susan E. BUTLER, Decatur, IL (US); Erin S. CRISWELL, Decatur, IL (US); Penelope PATTON, Decatur, IL (US)

Correspondence Address: WILLIAMS, MORGAN & AMERSON, P.C., 10333 RICHMOND, SUITE 1100, HOUSTON, TX, 77042, US

(73) Assignee: Tate & Lyle Ingredients America ,Inc.

(21) Appl. No.: 12/303,285

(22) PCT Filed: Jun. 13, 2007
(86) PCT No.: PCT/US2007/013841

§ 371 Date: Aug. 14, 2009

Related U.S. Application Data
(63) Continuation of application No. 11/613,365, filed on Dec. 20, 2006.
Application No. 11/613,365 is a continuation of application No. 11/424,586, filed on Jun. 16, 2006.
(60) Provisional application No. 60/910,729, filed on Apr. 9, 2007.
(60) Provisional application No. 60/912,275, filed on Apr. 17, 2007.

(51) Int. Cl. A23G 3/00; A23L 1/00; A23L 1/05; B65D 85/00

(52) U.S. Cl. 426/96; 426/138; 426/103; 426/390; 426/132

(57) ABSTRACT

An edible article comprises a food product and a film that encloses the food product. In one embodiment, the film comprises a major amount of pullulan on a dry solids basis, and a minor amount of at least two of glycerol, propylene glycol, sorbitol, and polyethylene glycol. In another embodiment, the film comprises a major amount of pullulan on a dry solids basis, gelatin, and at least two of glycerol, propylene glycol, sorbitol, and polyethylene glycol, and can also comprise salt. In another embodiment, the film comprises a first layer comprising a major amount of at least one food grade wax, a second layer comprising a major amount of pullulan and further comprising at least one plasticizer, and a third layer comprising at least one surfactant that is substantially immiscible with aqueous pullulan compositions but which adheres to pullulan surfaces, wherein the at least one surfactant is at least partially crystalline. In another embodiment, the film comprises a major amount of pullulan on a dry solids basis, at least one salt (and in some cases at least two salts), and at least one plasticizer. In another embodiment, the film comprises an edible film adhered to a peelable, flexible substrate, wherein the edible film comprises a major amount of pullulan on a dry solids basis and at least one plasticizer. The edible article can be manufactured by preparing a film-forming composition as described above, forming the film-forming composition into a film, and enclosing a food product with the film.

### BACKGROUND OF THE INVENTION

Some types of packaging material can be dissolved in water. For example, water soluble pouches made from polyvinyl alcohol (PVOH) film have been used to package pre-weighed farm chemicals and concrete additives. These PVOH pouches can be added to tanks or mixers, where the packaging material dissolves and the contents are released. PVOH pouches have also been used with pre-weighed laundry soap and dishwashing detergent. However, PVOH is not a food ingredient, so the PVOH technology has thus far been limited to non-food applications.

Edible films have been made from other film-forming polymers such as pullulan. For example, edible strips containing pullulan and a breath-freshening agent have been sold for human consumption. Cough medicines, vitamins, and dietary supplements have also been supplied in the form of edible strips.

Pullulan has a number of properties that make it suitable for use in edible compositions. However, one problem with pullulan films is their limited ability to elongate without breaking. This problem limits the ability of pullulan films to envelop other materials, as opposed to having other materials interspersed in the film itself. A survey of tensile strength and elongation properties of packaging films indicates that strength above 1,000 gram force and elongation of greater than 50% is likely to give pullulan-based films suitable for commercial packaging.

There is a need for improved methods of enclosing or packaging other materials in pullulan-based films or compositions.

### SUMMARY OF THE INVENTION

One aspect of the invention is an edible article that comprises a food product and a water-soluble film that encloses the food product. The film consists essentially of a major amount of pullulan on a dry solids basis, and a minor amount of more than one member selected from the group consisting of glycerol, propylene glycol, sorbitol, and polyethylene glycol. “Consists essentially of” in this context means that the composition is essentially free of polysaccharides other than those listed.

In some embodiments of the invention, the film comprises about 35-80% by weight pullulan on a dry solids basis. In some embodiments, the film comprises a plasticizer mixture included at up to about 40% by weight. The plasticizer mixture in some embodiments uses a combination of glycerol, propylene glycol, and sorbitol. The film optionally can further comprise citric acid, starch or a starch derivative (such as dextrin or maltodextrin), alginate, xanthan gum, modified cellulose, polydextrose, or a combination of two or more thereof.

In another embodiment of the edible article, the water-soluble film that encloses the food product comprises a major amount of pullulan on a dry solids basis, gelatin, and at least two of glycerol, propylene glycol, sorbitol, and polyethylene glycol. Optionally, the film can also comprise at least one salt, such as NaCl. The film can optionally also comprise at least one internal film release agent.

Another aspect of the invention is a water-soluble, edible film, comprising the above-described components.

Yet another aspect of the invention is a method for making the water-soluble, edible film. The method comprises (a) preparing a film-forming composition as described in various embodiments above, (b) coating a substrate with a solution or suspension comprising at least one surfactant, and (c) casting the film-forming composition on the substrate.

Another aspect of the invention is a method for making an edible article. The method comprises preparing a film-forming composition as described in various embodiments above; forming the film-forming composition into a water-soluble film; and enclosing a food product with the film. The components of the film-forming composition can be as described above.

In some embodiments of the invention, the film can be stretched longitudinally by at least about 50%, or at least about 100%, without breaking. In one embodiment, the food product can be enclosed by placing the food product between two pieces of film and heat-sealing the two pieces of film to form a sealed enclosure around the food product. Alternatively, the food product can be enclosed by placing the food product between two pieces of film and applying moisture and pressure to at least portions of the film to form a sealed enclosure around the food product. One specific method of enclosing that can be used is vacuum-forming the film around the food product.

Another aspect of the invention is an edible film that comprises a first layer comprising a major amount of at least one food grade wax; a second layer comprising a major amount of pullulan and further comprising at least one plasticizer; and a third layer comprising at least one surfactant that is substantially immiscible with aqueous pullulan compositions but which adheres to pullulan surfaces. The at least one surfactant is at least partially crystalline. In one embodiment, the at least one surfactant comprises sodium stearoyl lactylate. In one embodiment, the second layer further comprises particles of food grade wax.

Another aspect of the invention is an edible article that comprises a food product and edible film that encloses the food product. The film comprises first, second, and third layers, as described in the previous paragraph. The first layer, which comprises a major amount of at least one food grade wax, is in contact with the food product.

Another aspect of the invention is a method for making an edible film. The method comprises applying to a substrate a solution or suspension that comprises a major amount of at least one surfactant that is substantially immiscible with aqueous pullulan compositions; drying or concentrating the solution or suspension to form a first layer that comprises a major amount of dried surfactant that is at least partially crystalline; applying to the dried surfactant layer an aqueous solution or suspension that comprises pullulan, at least one plasticizer, and at least one food grade wax; and drying or concentrating the aqueous solution or suspension, whereby a second layer and a third layer are formed. The second layer is on top of the first layer and the third layer is on top of the second layer. The second layer comprises plasticizer and a major amount of pullulan and the third layer comprises a major amount of food grade wax.

Yet another aspect of the invention is an edible film that comprises a major amount of pullulan on a dry solids basis; at least one salt; and at least one plasticizer. In some embodiments, the film comprises at least two salts, such as NaCl and MgCl₂, for example.

Another aspect of the invention is an edible article that comprises a food product and edible film that encloses the food product, wherein the film is as described in the previous paragraph.

Another aspect of the invention is a film structure that comprises an edible film adhered to a peelable, flexible substrate. The edible film comprises a major amount of pullulan on a dry solids basis; and at least one plasticizer. In some embodiments, the flexible substrate comprises a polymeric film, such as a polyester film, for example.

### BRIEF DESCRIPTION OF THE DRAWINGS

FIG. 1 is a schematic drawing of a multi-layer film in accordance with one embodiment of the invention.

FIG. 2 is a schematic drawing of a film on a peelable, flexible substrate in accordance with one embodiment of the invention.

FIG. 3 is a schematic drawing of a pouch that contains a food product and is made from a film in accordance with one embodiment of the invention.

### DESCRIPTION OF SPECIFIC EMBODIMENTS

One embodiment of the present invention relates to edible articles which contain a food product and can be consumed orally or dissolved (entirely or partially) in water. These articles have an outer layer or surface made from a film-forming composition, and the food product is enclosed inside the outer layer.

The film-forming composition comprises a major amount of pullulan on a dry solids basis. (“A major amount” in this context means that the composition contains more pullulan on a dry solids basis than any other component.) In one embodiment of the invention, the film-forming composition comprises about 35-80% by weight pullulan on a dry solids basis. Optionally, in some embodiments of the invention, other film-forming materials can be included in the film-forming composition as well, such as alginates, xanthan gum, modified cellulose, polydextrose, starch or a starch derivative (such as dextrin or maltodextrin), and combinations of two or more such materials. Inclusion of one or more of these polymers can enhance film strength and reduce cost as compared to pullulan-only compositions.

The film-forming composition also includes a minor amount of plasticizer, in particular at least two of the plasticizers glycerol, propylene glycol, sorbitol, and polyethylene glycol. (“A minor amount” in this context means that the composition contains less total plasticizer than it does pullulan on a dry solids basis.) One commercially available polyethylene glycol that is suitable for use in the invention is polyethylene glycol molecular weight 200 (PEG 200). In one embodiment of the invention, the film-forming composition comprises the plasticizers glycerol, propylene glycol, and sorbitol. For example, the film-forming composition can comprise about 1-30% glycerol, about 1-30% propylene glycol, and about 1-30% by weight sorbitol on a dry solids basis. Each of these materials is commercially available. Optionally, in some embodiments, the composition can also include other plasticizers. In one embodiment of the invention, the film-forming composition comprises a plasticizer mixture at up to about 40% by weight.

A 20% d.s. pullulan solution in water that does not contain any plasticizer, after being cast on Mylar and then dried to residual moisture of 10% or less, results in a clear film that can be peeled away from the Mylar. The film exhibits high tensile strength, but can only be stretched and elongated about 10% in length before it breaks.

In general, pullulan-containing films that also contain plasticizers exhibit increased strength and elongation compared to pullulan films that do not contain plasticizers, up to a to point. However, increasing the plasticizer content of a pullulan film beyond this level often leads to greatly decreased tensile strength. For example, addition of individual food grade plasticizers to a pullulan polymer solution prior to casting and drying gave films with elongations above 10%, but at the expense of greatly reduced tensile strength.

Surprisingly, it has been found that pullulan compositions that include at least two of the plasticizers glycerol, propylene glycol, sorbitol, and polyethylene glycol can be used to produce pullulan films that have high elongation and high tensile strength, even at relatively high plasticizer concentrations. In at least some embodiments of the invention, the film can be elongated at least about 50%, and in some cases at least about 100%, without breaking. In certain embodiments, the elongation without breaking is at least about 200%, or at least about 300%. In some embodiments of the invention, these enhancements to the elongation properties of the film are achieved without a substantial reduction in tensile strength.

The composition optionally can also contain one or more additives that are suitable for use in foods, such as fillers, surfactants, stabilizers, organic acids (such as citric acid), and flavorings.

One specific embodiment of the invention is a water-soluble, edible film-forming composition that consists essentially of a major amount of pullulan on a dry solids basis, and a minor amount of more than one member selected from glycerol, propylene glycol, sorbitol, and polyethylene glycol. This composition can be formed into films having a thickness of less than 2.2 mils (0.0022 inches or 0.056 mm) that will exhibit tensile strength in excess of 1,000 grams force and elongation to break in excess of 50%.

In another specific embodiment of the invention, the water-soluble, edible film-forming composition consists essentially of a major amount of pullulan on a dry solids basis and minor amounts of (i) a co-polysaccharide selected from the group consisting of alginates, cellulose ethers, modified starches, and combinations thereof, and (ii) more than one member selected from the group consisting of glycerol, propylene glycol, sorbitol, and polyethylene glycol. (“A minor amount” in this context means that the composition contains less total plasticizer than it does pullulan on a dry solids basis, and also contains less total co-polysaccharide than it does pullulan on a dry solids basis.) The composition can be formed into a film having a thickness of less than 2.2 mils that will exhibit tensile strength in excess of 1,000 grams force and elongation to break in excess of 50%.

In another embodiment of the invention, the film-forming composition that can be used to form a water-soluble, edible film, comprises a major amount of pullulan on a dry solids basis, and also comprises lesser amounts of gelatin and at least two of glycerol, propylene glycol, sorbitol, and polyethylene glycol. The use of gelatin as a secondary polymer can maintain or improve elongation while maintaining film strength. Gelatin also gives the film a smooth surface without increased tackiness and blocking. In certain embodiments, the film-forming composition comprises about 35-80% by weight pullulan and about 0.5-22.5% by weight gelatin on a dry solids basis. Optionally, the composition can comprise the plasticizers glycerol, propylene glycol, and sorbitol. For example, in some embodiments of the invention, the film-forming composition can comprise about 1-30% glycerol, about 1-30% propylene glycol, and about 1-30% by weight sorbitol on a dry solids basis.

Optionally, the composition can also comprise at least one salt. It has been found that the addition of salt to the films improves film elongation. Typically, in order to improve elongation, surface properties are sacrificed such as blocking and tackiness. However, when salt is included in the composition to increase elongation, surface properties in many instances are improved. Films that contain salt and a suitable level of traditional plasticizer, do not block and are not tacky, and therefore can be rolled onto themselves more easily. Examples of suitable salts include NaCl and KCl. In certain embodiments of the invention, the concentration of salt in the film-forming composition is about 0.3-15% by weight on a dry solids basis. Films with a salt content of ˜10% or greater are cloudy with a powder finish as some of the salt precipitates out of the film to the surface on drying. Films with lower salt content of ˜5% or less still have good elongation and surface properties without any residual salt precipitating from the films.

As another option, the film-forming composition can comprise at least one internal film release agent, to make it easier to peel the film from the substrate surface on which it is cast. Suitable examples of internal film release agents include, but are not limited to, polyoxyethylene sorbitan monooleate, sodium lauryl sulfate, and combinations thereof. Polyoxyethylene (20) sorbitan monooleate is commercially available as Polysorbate 80.

Other details of the film-forming composition in this embodiment of the invention, and its use to enclose a food product, can be as discussed above with respect to other embodiments.

Techniques of forming films using pullulan compositions are well known in the art. For example, an aqueous pullulan solution can be cast onto a flat surface, and then heated and dried to form the film. Methods for controlling the thickness of the film are also well known.

In one embodiment of the invention, the water-soluble, edible film is formed by a method comprising preparing a film-forming composition as described above, coating a substrate (e.g., a stainless steel surface) with a solution or suspension that comprises at least one surfactant, and casting the film-forming composition on the substrate. After suitable heating and/or drying, the film can be peeled from the substrate.

Film gels that are cast directly onto a stainless steel substrate often do not release well from the steel, especially films that have 75-125% elongation to break. These types of films will often simply stretch out and become distorted when one attempts to remove them from untreated steel. In order to eliminate or reduce this problem, the steel substrate can be treated with solutions or suspensions that comprise release agents.

The coating of the substrate with the solution or suspension of a food grade surfactant (i.e., an external film release agent) makes it easier to peel the film away from the substrate. Suitable surfactants for this purpose include, but are not limited to, propylene glycol monostearate, sodium stearoyl lactylate, polyoxyethylene sorbitan monooleate (e.g., Polysorbate 80), sodium lauryl sulfate, salts of stearic acid, or a combination thereof. Suitable surfactants can be used in quantities up to 10% by weight in solutions of water and/or alcohol (e.g., isopropyl alcohol), or other suitable solvent systems.

There are many different ways that the film-forming composition can be used to enclose a food product. For example, a film can be formed into a pouch, the food product can be placed in the pouch, and then the opening in the pouch can be sealed, for example by application of heat and/or moisture. One specific technique that can be used is vacuum-forming the film around the food product. Vacuum forming has the advantage of requiring less extreme folding and bending of the film web under tension, as compared to some other methods of enclosing a product with a film.

The food grade films of the present invention can have the tensile strength and elongation properties necessary to successfully produce edible packages on commercial vacuum-forming equipment. They also can have the ability to form many different shapes and work on complex molds more successfully than at least some other commercial film-forming materials. In some embodiments, the films exhibit tensile strength in excess of 1,000 grams force and elongation to break in excess of 50%. In some embodiments, the films have elongation to break of 75-125%.

A wide variety of food products can be enclosed, including ones that need to be dissolved or dispersed in water for cooking and ones that are supplied in single-serve packages for human consumption. Examples of such food products include, but are not limited to powdered beverage mixes (such as cocoa drink products, soft drink products, and cider drink products), powdered cheese products, powdered egg products, candy, dry soup and casserole mixes, food dyes and spices. The food product itself can be, but does not necessarily have to be, water-soluble.

For example, the film can be utilized in the packaging of a dry food ingredient or an oil based liquid food ingredient. The films can be used in the packaging of any foodstuff that requires addition to water or water-containing food products. This could include, for example, drink mixes, vitamin and mineral additives, colors, flavors, and any other ingredients that could be added to food during batch preparation at a food production plant, or even during food preparation by an individual prior to consumption.

The edible films of the present invention, at least in many embodiments, have increased elongation without being tacky. The use of such films in the packaging of food products can reduce waste, as the entire package can be consumed, leaving nothing to throw away. When utilized for packaging ingredients needed for batch cooking, the precise amount of ingredient added would be known. There would be no loss of the ingredient by sticking to the inside of the package, since the entire package would be cooked into the product.

In another embodiment of the invention, a multilayer edible film comprises a first layer that comprises a major amount of at least one food grade wax; a second layer that comprises a major amount of pullulan and further comprises at least one plasticizer; and a third layer. The third layer comprises at least one surfactant that is substantially immiscible with aqueous pullulan compositions but which adheres to pullulan surfaces. The at least one surfactant is at least partially crystalline in form. The surfactant can be, for example, sodium stearoyl lactylate. In some embodiments, the concentration of the at least one surfactant in the overall film is about 0.001-0.1% by weight, or in some cases about 0.001-0.05%. The second layer can optionally also comprise particles of food grade wax.

As in some of the other embodiments of the invention, the second layer can comprise about 35-80% by weight pullulan on a dry solids basis, and the plasticizer in the second layer can comprise at least two of glycerol, propylene glycol, sorbitol, and polyethylene glycol. In one particular embodiment, the second layer comprises glycerol, propylene glycol, and sorbitol, for example, about 1-30% glycerol, about 1-30% propylene glycol, and about 1-30% by weight sorbitol on a dry solids basis. As another option, the second layer can comprise, in addition to the pullulan, a secondary film-forming material, such as about 0.5-22.5% by weight gelatin on a dry solids basis, starch, a starch derivative, alginate, xanthan gum, collagen, polydextrose, or a combination of two or more thereof. As yet another option, the second layer can also comprise at least one salt, such as NaCl, MgCl₂, or a combination thereof, for example. If salt is present, it preferably is present in the second layer at a concentration of about 0.3-15% by weight on a dry solids basis.

Another embodiment of the invention is an edible article, comprising a food product and edible film that encloses the food product, wherein the film comprises first, second, and third layers, as described above. The first layer is in contact with the food product.

Another embodiment of the invention is a method for making an edible film. The method comprises:

applying to a substrate a solution or suspension that comprises a major amount of at least one surfactant that is substantially immiscible with aqueous pullulan compositions;

drying or concentrating the solution or suspension to form a first layer that comprises a major amount of dried surfactant that is at least partially crystalline;

applying to the dried surfactant layer an aqueous solution or suspension that comprises pullulan, at least one plasticizer, and at least one food grade wax; and

drying or concentrating the aqueous solution or suspension, whereby a second layer and a third layer are formed. The second layer is on top of the first layer and the third layer is on top of the second layer. The second layer comprises plasticizer and a major amount of pullulan and the third layer comprises a major amount of food grade wax.

This three layered structure can be formed in a single pass through a continuous film casting process. In one embodiment, the procedure first calls for application of a surfactant such as sodium stearoyl lactylate (SSL, 2% in isopropanol) to a stainless steel casting surface as a release agent. The solvent rapidly evaporates to give a dried release layer of SSL prior to casting. Next an aqueous pullulan casting solution, containing a food grade wax emulsion as one of the formulation components, is deposited as a thin, uniform film on the casting is surface. The film is then subjected to controlled drying conditions and is dried to moisture of less than 15% by weight over a few minutes. During the drying process, the wax particles tend to migrate toward the open surface of the film due to their relatively low surface energy. After the film is dried, a layer of partially crystalline SSL is found on the film surface that was in contact with the stainless steel casting substrate. Additionally, a layer of wax particles is found on the surface of the film that was open to the air during the drying process. In between these two surface layers is the middle layer containing predominantly pullulan and the other water soluble ingredients in the casting formulation.

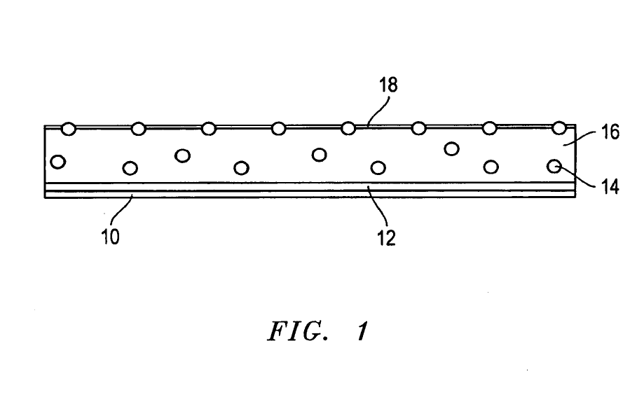

FIG. 1 shows in schematic form one embodiment of this three layered film. There is an SSL crystal layer 10 located at the interface between the film and the substrate on which it is cast. The central layer in the film is the matrix 16 which comprises pullulan. There is also an SSL-rich diffusion layer 12 between the pullulan matrix 16 and the SSL crystal layer 10. Within the pullulan matrix 16 are a plurality of wax particles 14, and there is a thin wax layer 18 on the film surface.

The pullulan film formulation can contain up to about 10% wax by weight, but a wax content of less than about 5% is usually preferred. Suitable waxes include paraffin wax and other food-grade waxes such as carnauba, candelilla, or beeswax. The surfactant SSL can be replaced by any surfactant that is immiscible with the aqueous casting gel, but exhibits good adhesion to pullulan film surfaces.

The surface (e.g., SSL) layer not only provides improved release of the dried film from the stainless steel casting belt, but also gives a slight hydrophobic character to the side of the film that will be used on the outside of the edible package. This slight hydrophobicity decreases the sensitivity of the film to changes in environmental humidity. The pouch does not become so hydrophobic as to be insoluble in water.

The wax layer can be used for the side of the film in contact with the food grade fill material that will be contained in the edible pouch. The wax layer decreases the moisture migration between the fill material and the film layer of the pouch itself. The wax layer also provides significant anti-blocking properties to the film. Another added benefit to this wax layer is that it provides enhanced slip of the film in contact with the packaging machine during high speed conversion operations.

The middle layer of predominantly pullulan can provide the required strength and is flexibility of the three layered film structure.

Thus, various embodiments of this three layered film can provide improved functional properties such as increased resistance to environmental humidity, increased resistance to moisture migration from food-grade fill materials into the packaging film, and improved slip to more easily slide through high speed packaging equipment. These enhancements can provide improved shelf life for packaged food products and can extend the range of equipment that can be used to convert the films into edible packaging.

Another embodiment of the invention is an edible film that comprises a major amount of pullulan on a dry solids basis, at least one salt, and at least one plasticizer. In some embodiments, the film comprises at least two salts, such as combinations of NaCl and MgCl₂, for example. In some embodiments, the at least one salt is present in the film at a concentration of about 0.3-15% by weight on a dry solids basis. The plasticizers and other components of the film can be as described above with respect to other embodiments of the invention. The film of this embodiment can be used to prepare an edible article that comprises a food product that is enclosed by the edible film.

Another embodiment of the invention is a film structure that comprises an edible film adhered to a peelable, flexible substrate. The edible film comprises a major amount of pullulan on a dry solids basis, and at least one plasticizer. In some embodiments, the flexible substrate comprises a polymeric film, such as a polyester film, for example. In one embodiment, the flexible substrate can be a biodegradable polymer film, such as one that comprises polylactic acid, polyglycolic acid, copolymers of lactic and glycolic acid, or mixtures of two or more such polymers. The plasticizers and other components can be as described above with respect to other embodiments of the invention. The film of this embodiment can be used to prepare an edible article that comprises a food product that is enclosed by the edible film.

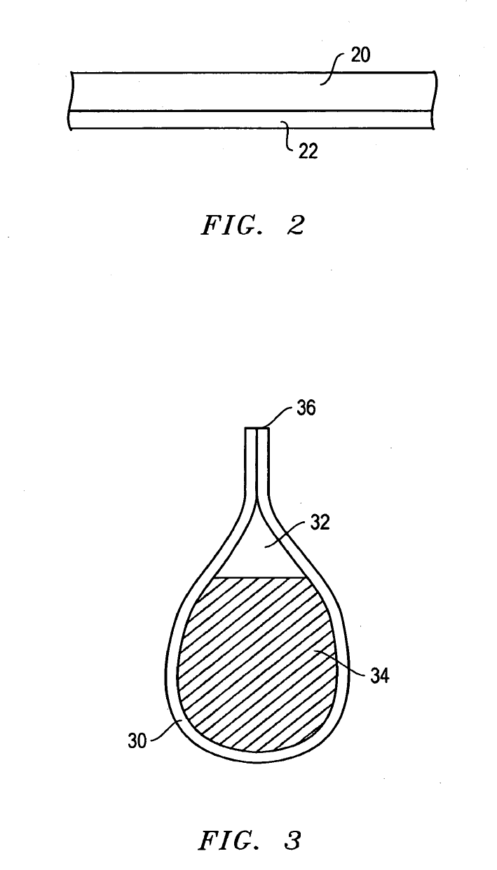

FIG. 2 shows one embodiment of this film structure. A pullulan film 20 as described above is releasably adhered to a polyester film 22, from which it can be removed at the desired time.

This bilayered film structure can be especially useful in a high speed packaging operation. A potential problem associated with using edible film on conventional packaging equipment is that all film surfaces must be kept clean because the packaging film is part of is the edible product. This is different from the conventional packaging strategy where one surface of the packaging film comes in contact with the food and the other surface is exposed and protects the food product from the environment. In one embodiment of the invention, the outer surface of the edible film is protected by a polyester layer during packaging and can be easily removed prior to using the food product contained in the edible package.

Any of the films described herein can be used to package a food product, for example by forming a pouch as shown in cross-section in FIG. 3, where the film 30 encloses an inner contained area 32 into which is placed a food product 34. Edges 36 of the film can be sealed to form an enclosed package.

### EXAMPLES

The following experimental methods were used in the examples described below.

Preparation of Pullulan and other Polymer Solutions

Polymer solutions were prepared to have less than 10,000 centipoises viscosity. Water was placed in a vessel and agitated, and then the dry polymer powder was added to the vortex of the stirring liquid over time. Stirring at 100-1000 rpm was continued for 30-60 minutes, then the solution was allowed to rest for at least two hours prior to use.

### Incorporation of Plasticizers and Other Additives

Polymer solutions were blended as needed to give the desired ratios and concentrations, and then the oligomers, plasticizers, and other additives were added beat to the polymer solutions with mixing over time.

### Film Casting and Drying

Aqueous solutions were cast onto Mylar film by machine or by hand using drawdown bars with a gap of either 20 or 40 mils at a rate of about 1 meter per second. The Mylar film is was taped onto 0.50 in thick glass sheets prior to solution casting. The whole assembly (casting, Mylar, and glass) was placed into a controlled drying chamber set for 140° F. and 30% relative humidity (RH) for 2-3 hours to dry the pullulan films.

### Film Conditioning and Testing

Films were conditioned in a controlled environment room set for 70° F. and 50% RH for 1 to 5 days (average 3) prior to testing. Samples were transferred to the testing area in Zip-Loc® bags. Samples were tested and evaluated for tensile strength (gram force) and % elongation using a small laboratory Instron physical testing unit. In the test, a metal probe with an elliptical tip is forced thru the plane of a tightly held piece of film. The amount of force required to break the film, and the distance the probe travels to break the film are used to calculate the material properties.

### Pouch Production Via Vacuum Forming

A die was selected and placed on the table under a vertically-movable frame. A sheet of film (7 in×11 in) was placed on the bottom part of the frame. The upper part of the frame was lowered and locked onto the bottom part. A vacuum was pulled through the die, the film was lowered onto the die and sucked into it, forming a pouch, and then the pouch was filled with selected material.

### Heat Sealing

A second piece of film was laid smoothly on top of the pouch. A hot iron (200-300° F.) was manually pressed onto both pieces of film at the edge of the filled area. The iron was held in place for 2-5 seconds.

### Moisture Sealing

A second piece of film was wrapped around a block and was quickly pressed into a damp paper towel. The lightly moisturized film was pressed onto the previously formed pouch for about 2-5 seconds.

### Example 1

Commercially available pullulan from Hayashibara (PI-20) was used to prepare films with one or more of the following additives: glycerol, propylene glycol (PPG), Sorbitol Special (SorbS; SPI Pharma; 40-55% sorbitol, 15-30% sorbitol anhydrides, and 1-10% mannitol), Nu-Col 2004 (NC2004; Tate & Lyle modified starch), Star-Dri 5 (Tate & Lyle maltodextrin), MiraSperse 2000 (MS2000; Tate & Lyle modified starch), DuraGel (Tate & Lyle modified starch), TenderJel C (Tate & Lyle modified starch), and sodium alginate. The specific compositions are shown in Table 1A.

TABLE 1A

| Ref. | total | % | | | | % | |
|---|---|---|---|---|---|---|---|
| No. | % d.s. | pullulan | additive 1 | % additive 1 | % glycerol | PPG | % SorbS |
| 1-1 | 20.0% | 80.0% | | | 20.0% | | |
| 1-2 | 20.0% | 48.0% | Na alginate | 12.0% | 10.0% | 10.0% | 20.0% |
| 1-3 | 20.0% | 48.0% | NC2004 | 12.0% | 10.0% | 10.0% | 20.0% |
| 1-4 | 20.0% | 48.0% | Star-Dri 5 | 12.0% | 10.0% | 30.0% | |
| 1-5 | 20.0% | 80.0% | Star-Dri 5 | 20.0% | | | |
| 1-6 | 20.0% | 48.0% | Na alginate | 12.0% | 10.0% | 30.0% | |
| 1-7 | 20.0% | 80.0% | TenderJel C | 20.0% | | | |
| 1-8 | 20.0% | 48.0% | DuraGel | 12.0% | 10.0% | 30.0% | |
| 1-9 | 20.0% | 80.0% | DuraGel | 20.0% | | | |
| 1-10 | 34.0% | 48.9% | MS2000 | 12.0% | 9.8% | 29.3% | |
| 1-11 | 37.0% | 41.9% | MS2000 | 24.6% | 8.3% | 25.1% | |
| 1-12 | 20.0% | 48.0% | NC2004 | 12.0% | 10.0% | 30.0% | |
| 1-13 | 20.0% | 80.0% | MS2000 | 20.0% | | | |
| 1-14 | 20.0% | 80.0% | NC2004 | 20.0% | | | |
| 1-15 | 20.0% | 80.0% | | | | 20.0% | |
| 1-16 | 20.0% | 80.0% | | | 20.0% | | |

The results of tests of the film properties are given in Table 1B.

TABLE 1B

| | Film | | | | |
|---|---|---|---|---|---|
| Ref. | Thickness | Force | Elongation | Force | |
| No. | (mil) | (gram) | (percent) | (coeff. var.) | N |
| 1-1 | 2.0 | 2,018 | 15% | 15% | 3 |
| 1-2 | 2.2 | 1,068 | 62% | 9% | 5 |
| 1-3 | 2.2 | 841 | 57% | 15% | 5 |
| 1-4 | 2.6 | 1,666 | 22% | 5% | 4 |
| 1-5 | 2.0 | 3,174 | 12% | 16% | 4 |
| 1-6 | 1.7 | 1,069 | 7% | 32% | 5 |
| 1-7 | 2.4 | 2,114 | 5% | 12% | 4 |
| 1-8 | 1.6 | 827 | 5% | 10% | 4 |
| 1-9 | 3.0 | 1,818 | 4% | 3% | 4 |
| 1-10 | 2.8 | 763 | 4% | 3% | 5 |
| 1-11 | 3.1 | 755 | 4% | 4% | 5 |
| 1-12 | 1.8 | 569 | 3% | 22% | 4 |
| 1-13 | 2.0 | 1,113 | 2% | 12% | 4 |
| 1-14 | 2.0 | 981 | 2% | 34% | 4 |
| 1-15 | 2.4 | 857 | 2% | 15% | 5 |
| 1-16 | 2.4 | 1,988 | 17% | 4% | 4 |

Films containing a combination of three plasticizers (glycerol, propylene glycol and sorbitol special) gave elongations above 50% at high strength in samples 1-2 and 1-3.

### Example 2

Films were prepared containing pullulan and additional ingredients shown in Table 2A.

TABLE 2A

| Ref. | total % | % | % Na | % | % | % | | % | % citric |
|---|---|---|---|---|---|---|---|---|---|
| No. | d.s. | pullulan | alginate | Star-Dri 5 | NC2004 | glycerol | % PPG | SorbS | acid |
| 2-1 | 20.0% | 80.0% | | | | 20.0% | | | |
| 2-2 | 22.8% | 56.0% | 2.8% | 11.2% | | 5.0% | 10.0% | 15.0% | |
| 2-3 | 25.0% | 56.0% | 2.8% | 11.2% | | | 12.0% | 18.0% | |
| 2-4 | 25.0% | 56.0% | 2.8% | 11.2% | | | 10.0% | 20.0% | |
| 2-5 | 30.0% | 56.0% | 2.8% | 8.4% | 2.8% | 0.0% | 10.0% | 20.0% | 0.0% |
| 2-6 | 30.0% | 56.0% | 2.8% | 8.4% | 2.8% | | | 20.0% | 10.0% |
| 2-7 | 25.0% | 56.0% | 2.8% | 11.2% | | | | 20.0% | 10.0% |
| 2-8 | 25.0% | 56.0% | 2.8% | 11.2% | | 5.0% | 10.0% | 15.0% | |
| 2-9 | 25.0% | 56.0% | 2.8% | 11.2% | | | 10.0% | 20.0% | |
| 2-10 | 25.0% | 48.0% | 2.4% | 9.6% | | 10.0% | 10.0% | 20.0% | |
| 2-11 | 30.0% | 56.0% | 2.8% | 8.4% | 2.8% | 0.0% | 12.0% | 18.0% | |
| 2-12 | 25.0% | 53.2% | 2.8% | 11.2% | 2.8% | 5.0% | 10.0% | 15.0% | |
| 2-13 | 25.0% | 56.0% | 2.8% | 11.2% | | 5.0% | 10.0% | 15.0% | |
| 2-14 | 30.0% | 48.0% | 2.4% | 7.2% | 2.4% | 10.0% | 10.0% | 20.0% | |
| 2-15 | 30.0% | 48.0% | 2.4% | 7.2% | 2.4% | 10.0% | 10.0% | 20.0% | |
| 2-16 | 24.0% | 57.0% | 2.6% | 10.4% | | 5.0% | 10.0% | 15.0% | |
| 2-17 | 30.0% | 48.0% | 2.4% | 7.2% | 2.4% | 10.0% | 10.0% | 20.0% | |
| 2-18 | 25.0% | 50.4% | 2.4% | 7.2% | | 5.0% | 10.0% | 15.0% | 10.0% |
| 2-19 | 25.0% | 52.0% | 2.6% | 10.4% | | 5.0% | 5.0% | 15.0% | 10.0% |
| 2-20 | 25.0% | 56.0% | 2.8% | 11.2% | | 5.0% | 5.0% | 15.0% | 5.0% |
| 2-21 | 26.4% | 48.0% | 2.4% | 9.6% | | 5.0% | 10.0% | 15.0% | 10.0% |
| 2-22 | 24.0% | 57.0% | 2.6% | 10.4% | | 5.0% | 10.0% | 15.0% | |
| 2-23 | 24.0% | 48.0% | 2.4% | 9.6% | | 5.0% | 10.0% | 15.0% | 10.0% |
| 2-24 | 25.0% | 56.0% | 2.8% | 11.2% | | 5.0% | 10.0% | 15.0% | |

Tests were performed to determine the properties of these films, and the results are given in Table 2B.

TABLE 2B

| | Film | | | Force | |
|---|---|---|---|---|---|
| | Thickness | Force | Elongation | (coeff. | |
| Ref. No. | (mil) | (gram) | (percent) | var.) | N |
| 2-1 | 2.8 | 1,644 | 10% | 9% | 5 |
| 2-2 | 5.9 | 3,820 | 90% | 4% | 4 |
| 2-3 | 5.1 | 2,799 | 111% | 3% | 3 |
| 2-4 | 5.6 | 2,766 | 103% | 17% | 5 |
| 2-5 | 5.4 | 2,570 | 93% | 16% | 5 |
| 2-6 | 5.6 | 2,417 | 83% | 9% | 3 |
| 2-7 | 5.5 | 2,396 | 67% | 3% | 5 |
| 2-8 | 5.2 | 2,374 | 122% | 3% | 4 |
| 2-9 | 6.1 | 2,080 | 266% | 5% | 5 |
| 2-10 | 6.3 | 1,908 | 161% | 5% | 5 |
| 2-11 | 5.5 | 1,892 | 151% | 9% | 5 |
| 2-12 | 4.3 | 1,581 | 271% | 4% | 3 |
| 2-13 | 4.4 | 1,500 | 133% | 10% | 5 |
| 2-14 | 2.2 | 1,277 | 65% | 11% | 4 |
| 2-15 | 2.2 | 1,264 | 55% | 2% | 5 |
| 2-16 | 5.5 | 1,188 | 275% | 9% | 5 |
| 2-17 | 2.1 | 1,166 | 60% | 4% | 5 |
| 2-18 | 4.9 | 1,156 | 342% | 5% | 5 |
| 2-19 | 5.5 | 1,127 | 193% | 9% | 5 |
| 2-20 | 4.7 | 1,099 | 215% | 14% | 5 |
| 2-21 | 6.0 | 1,056 | 213% | 5% | 5 |
| 2-22 | 4.7 | 1,028 | 231% | 3% | 5 |
| 2-23 | 5.4 | 1,025 | 350% | 8% | 5 |
| 2-24 | 2.1 | 1,019 | 105% | 10% | 5 |

The films made with STAR-DRI 5 maltodextrin and sodium alginate (and optionally Nu-Col 2004) with pullulan as the predominant polymer showed high tensile strength. High elongations were seen in films containing glycerol, propylene glycol and sorbitol (and optionally citric acid) with pullulan as the predominant polymer. Variations in thickness resulted in films with tensile strength in excess of 1,000 grams force and elongation to break in excess of 50%.

### Example 3

The following films were prepared for testing on a laboratory vacuum forming packaging apparatus:

TABLE 3A

| Ref. | Total % | % | % Na | % Star- | % | | % | other | % other |
|---|---|---|---|---|---|---|---|---|---|
| No. | d.s. | pullulan | alginate | Dri 5 | glycerol | % PPG | SorbS | additive(s) | additive(s) |
| 1 | 20.0 | 80.0 | | 20.0 | | | | | |
| 2 | 24.8 | 60.0 | 3.0 | 12.0 | 6.3 | 6.3 | 12.5 | | |
| 3 | 25.0 | 56.0 | 2.8 | 11.2 | | 10.0 | 20.0 | | |
| 4 | 25.0 | 56.0 | 2.8 | 11.2 | 5.0 | 10.0 | 15.0 | | |
| 5 | 25.0 | 50.4 | 2.4 | 7.2 | 5.0 | 10.0 | 15.0 | citric acid | 10.0 |
| 6 | 24.1 | 52.0 | 2.6 | 7.8 | 10.0 | 10.0 | 15.0 | NC2004/ | 2.6/10.0 |
| | | | | | | | | citric acid | |

Tests were performed to evaluate the film properties, and the results are shown in Table 3B.

TABLE 3B

| | Film | | | | |
|---|---|---|---|---|---|
| Film | Thickness | | Elongation | Force | |
| Ref. No. | (mil) | Force (gram) | (%) | (% coeff. var.) | N |
| 1 | 2.1 | 3,174 | 12 | 8 | 5 |
| 2 | 2.6 | 1,600 | 47 | 14 | 5 |
| 3 | 2.2 | 2,766 | 100 | 17 | 5 |
| 4 | 5.9 | 1,500 | 130 | 10 | 5 |
| 5 | 6.0 | 1,131 | 250 | 5 | 5 |
| 6 | 5.8 | 879 | 216 | 9 | 5 |

The following dies were used in the vacuum packaging tests:

Die 1) Half egg-shaped: 2.50 in L by 1.88 in W by 0.69 in D—maximum depth tapered down from edge.

Die 2) Rectangular: 4.50 in L by 2.75 in W by 0.50 in D—uniform depth straight down from edge.

Die 3) Half tube: 1.88 in L by 0.75 in W by 0.50 in D—maximum depth tapered down from edge.

Die 4) Seven half cylinders: 2.00 in L by 0.75 in W by 0.50 in D—maximum depth tapered down from edge, each cylinder spaced 0.38″ apart.

Die 5) Tapered Square: 1.88 in L by 1.88 in W by 0.75 in D—maximum depth tapered down from edge.

Various food products were enclosed with the films as described below, forming edible, water soluble packages.

### Example 3-1

Film #6 was successfully vacuum formed using Die #1 and about 12 grams of finely powdered ALLEGGRA® FS74 egg product was filled in the pouch. Film #1 was successfully used to close the package by heat sealing.

### Example 3-2

Film #5 was successfully vacuum formed using Die #1 and about 20 grams of finely powdered Swiss Miss® Hot Cocoa Mix was filled in the pouch. Film #1 was unsuccessfully used to close the package due to fracture during heat sealing.

### Example 3-3

Film #5 was successfully vacuum formed using Die #1 and about 12 grams of finely powdered ALLEGGRA® FS74 egg product was filled in the pouch. Film #5 was successfully used to close the package by heat sealing.

### Example 3-4

Film #3 was successfully vacuum formed using Die #1 and about 20 grams of finely powdered Swiss Miss® Hot Cocoa Mix was filled in the pouch. Film #3 was successfully used to close the package by heat sealing.

### Example 3-5

Film #4 was successfully vacuum formed using Die #1 and about 12 grams of finely powdered ALLEGGRA® FS74 egg product was filled in the pouch. Film #4 was successfully used to close the package by heat sealing.

### Example 3-6

Film #4 was successfully vacuum formed using Die #2 and about 28 grams of finely powdered Swiss Miss® Hot Cocoa Mix was filled in the pouch. Film #4 was successfully used to close the package by heat sealing. This package was later found to have a minute hole in the deep corner of a vacuum formed region.

### Example 3-7

Film #3 was successfully vacuum formed using Die #2 and about 40 grams of finely powdered Swiss Miss® Hot Cocoa Mix was filled in the pouch. Film #3 was successfully used to close the package by heat sealing.

### Example 3-8

Film #4 was successfully vacuum formed using Die #2 and about 28 grams of finely powdered Swiss Miss® Hot Cocoa Mix was filled in the pouch. Film #4 was successfully used to close the package by heat sealing. This package was a redo of Example 5-6 and showed no defects.

### Example 3-9

Film #1 was unsuccessfully vacuum formed using Die #2. The film shattered to bits.

### Example 3-10

Film #2 was successfully vacuum formed using Die #2 and about 24 grams of finely powdered ALLEGGRA® FS74 egg product was filled in the pouch. Film #4 was successfully used to close the package by heat sealing. This package was later found to have a leak due to a heat sealing defect.

### Example 3-11

Film #5 was successfully vacuum formed using Die #3 and about 5 grams of finely powdered Crystal Light® Soft Drink Mix was filled in the pouch. Film #4 was successfully used to close the package by heat sealing.

### Example 3-12

Film #5 was successfully vacuum formed using Die #4 and about 5 grams of finely powdered Crystal Light® Soft Drink Mix was filled in each of seven pouches. Film #5 was successfully used to close the package by heat sealing. This film was capable of filling multiple adjacent cavities in a single vacuum forming operation.

### Example 3-13

Film #6 was successfully vacuum formed using Die #4 and about 4 grams of finely powdered Alpine® Spiced Cider Sugar Free Drink Mix was filled in each of seven pouches. Film #6 was successfully used to close the package by heat sealing. This film was capable of filling multiple adjacent cavities in a single vacuum forming operation.

### Example 3-14

Film #4 was successfully vacuum formed using Die #4 and about 5 grams of finely powdered Easy Mac® Cheese Powder was filled in each of seven pouches. Film #4 was successfully used to close the package by heat sealing. This film survived but seemed to be at the limit of its elongation and gave audible signs of stress during vacuum forming.

### Example 3-15

Film #3 was successfully vacuum formed using Die #1 and about 17 grams of finely powdered Easy Mac® Cheese Powder was filled in the pouch. Film #3 was successfully used to close the package by heat sealing.

### Example 3-16

Film #2 was successfully vacuum formed using Die #1 and about 17 grams of finely powdered Easy Mac® Cheese Powder was filled in the pouch. Film #3 was successfully used to close the package by heat sealing. This package was later found to have a leak due to a heat sealing defect.

### Example 3-17

Film #4 was successfully vacuum formed using Die #2 and about 40 grams of finely powdered Easy Mac® Cheese Powder was filled in the pouch. Film #4 was successfully used to close the package by heat sealing. This package was later found to have a leak due to a heat sealing defect.

### Example 3-18

Film #3 was successfully vacuum formed using Die #1 and about 17 grams of finely powdered Easy Mac® Cheese Powder was filled in the pouch. Film #3 was successfully used to close the package by water sealing.

### Example 3-19

Film #5 was successfully vacuum formed using Die #5 and about 8 grams of finely powdered Easy Mac® Cheese. Powder was filled in the pouch. Film #5 was successfully used to close the package by water sealing.

### Example 3-20

Film #3 (at 6 mil) was successfully vacuum formed using Die #5 and about 8 grams of finely powdered Easy Mac® Cheese Powder was filled in the pouch. Film #3 (at 6 mil) was successfully used to close the package by water sealing.

### Example 3-21

A blue colored and peppermint flavored film of 2 mil thickness was made using the following ingredients (all in % w/w, d.s. basis): pullulan (PI-20) 50%, tapioca dextrin (F4-800) 13%, glycerol 6%, propylene glycol 13%, and sorbitol 19%. The film was formed into a small ½ inch square pouch using a laboratory impulse sealer. Each pouch was filled with about 0.25 g of strawberry flavored Pop Rocks® candy and sealed. Thus, this test is produced an edible, two-part confectionary where the immediate flavor of the film is supplanted by the flavor and sensory attributes of the Pop Rocks® candy once the film is dissolved in the mouth.

### Example 4

A 100 g film solution is prepared by dissolving 15.46 g pullulan in 80 g deionized water. To this 1.142 g glycerin, 2.28 g sorbitol, 0.572 g propylene glycol, 0.01 g sodium lauryl sulfate, 0.01 g Polysorbate-80, and 0.02 g sodium benzoate are added with stirring. Finally, 0.5 g gelatin-1385P was added with stirring. The solution is heated to 70° C. for 30 minutes to fully dissolve the gelatin. The solution is continually stirred as it cools to room temperature which keeps the gelatin in solution. The gel is degassed by either sitting overnight or centrifuging. The gels are then cast onto treated stainless steel and dried to a moisture level of 7.5-9.5%. The film can then be peeled from the steel.

### Example 5

A 100 g film solution is prepared by dissolving 14.76 g pullulan in 80 g deionized water. To this 1.334 g glycerin, 2.66 g sorbitol, 0.2 g propylene glycol, 1 g NaCl, 0.01 g sodium lauryl sulfate, 0.01 g Polysorbate-80, and 0.02 g sodium benzoate are added with stirring. The gel is degassed by either sitting overnight or centrifuging. The gels are then cast onto treated stainless steel and dried to a moisture level of 7.5-9.5%. The film can then be peeled from the steel.

### Example 6

A 100 g film solution is prepared by dissolving 14.96 g pullulan in 80 g deionized water. To this 1.6 g sorbitol, 1.4 g polyethylene glycol, 2 g NaCl, 0.01 g sodium lauryl sulfate, 0.01 g Polysorbate-80, and 0.02 g sodium benzoate are added with stirring. The gel is degassed by either sitting overnight or centrifuging. The gels are then cast onto treated stainless steel and dried to a moisture level of 7.5-9.5%. The film can then be peeled from the steel.

### Example 7

Film samples prepared according to Examples 4-6 (labeled samples 4a, 5a, and 6a in the table below) were tested to determine their tensile strength and percent elongation to break. The same tests were also performed on comparison film samples (labeled as samples 4b, 5b, and 6b in the following table) that contained the same ingredients, except that they contained no gelatin or salt.

### Film Testing Protocol

To measure tensile strength and elongation to break, a sample of film is placed between two aluminum blocks, which are held securely together by screws and wing nuts. The blocks have an identical pattern of five holes drilled through them. A cylindrical probe is attached to the arm of an Instron testing unit. The test is run by punching the probe through the film. Five repetitions are performed—one test per hole—without reloading the sample. The block is merely re-positioned to align a new hole with the probe. Calculations use the data averaged from all runs.

The Instron software is programmed to start measuring when there is 1 gf recorded on the load cell, and records the distance the probe travels beyond this, through the hole drilled in the bottom plate. As the probe travels through the hole in the bottom plate, the film is distended and finally ruptures. As well as deformation, the instrument also records the resistance the film exerts over the course of deformation as gram force exerted on the load cell. Even though the film is being pushed rather than pulled in this test, the data can be treated as a conventional tensile test.

Film strain can be determined as follows. The film is stretched between the tip of the probe and the supporting edge of the blocks. The initial “length” of the test sample is defined as the radius of the hole (“a”). The distended length can be calculated from this initial length and the distance the probe has traveled. The distended length is essentially the hypotenuse of a right triangle, with the hole radius, a as one side of the triangle and distance traveled by the probe, b, as the second side. The distended length of the film, c, (the hypotenuse), can be calculated:

c²=a²+b².

c=(a²+b²)^{1/2}.

The diameter of each hole is 13 mm, so the radius is 6.5 mm. Strain is calculated as follows:

$$Strain = \frac{( distended length , c - 6.5 )}{6.5}$$

Percent elongation is the strain presented as a percentage rather than a fraction. The cross sectional area of the probe tip is 0.0085 cm². To calculate the tensile strength, the force at break or maximum load force is divided by the cross sectional area. Since the force is recorded in grams, it is then divided by 1000 to obtain the result in Kgf/sq cm. The calculation is as follows:

Tensile Strength=max. force (gf)/0.0085 sq cm/1000

### Blocking Analysis

In order to measure the blocking of the films, a subjective test is used. For this test, three pieces of film are cut and placed overlapping, front-to-back on a piece of Mylar, and then covered with another piece of Mylar. A ½-inch thick sheet of glass is placed on top of the stack in order to apply pressure to the films. After one week the films are peeled apart and scored as to ease of peel by the following scale:

0: Not blocking

1: Easily pulls apart

2: Pulls apart with some effort

3: Pulls apart with great effort either tearing a piece or only one piece will peel off.

4: Completely stuck. Does not peel apart.

The results of these tests are summarized in Table 4 below:

TABLE 4

| | | Tensile strength | | Blocking score |
|---|---|---|---|---|
| Sample | Additive | (Kg/sq cm) | Elongation % | (0-4) |
| 4a | gelatin | 278.7 | 73.3 | 2 |
| 4b | none | 359 | 50.4 | 2 |
| 5a | 5% NaCl | 141.4 | 402.4 | 4 |
| 5b | none | 351.3 | 49.2 | 1 |
| 6a | 10% NaCl | 292.1 | 125 | 1 |
| 6b | none | 350.5 | 103.2 | 4 |

The data indicate that both gelatin and salt can improve elongation. While the gelatin films usually require some other additive to combat blocking, the gelatin does not make blocking worse than similar films with less elongation. The data also indicates that salt can drastically improve elongation, and when used with r lower levels of plasticizers, it can greatly improve blocking as well.

### Example 8

A 100 g surfactant solution is made by dissolving 5 g of sodium stearoyl lactylate in 95 g isopropyl alcohol. This is then sprayed or mopped onto stainless steel in a thin even layer and the liquid allowed to evaporate. Film gels may then be cast onto the treated surface and dried.

### Example 9

A 100 g surfactant solution is made by dissolving 5 g of propylene glycol monostearate in 95 g isopropyl alcohol. This is then sprayed or mopped onto stainless steel in a thin even layer and the liquid allowed to evaporate. Film gels may then be cast onto the treated surface and dried.

### Example 10

A 100 g surfactant solution is made by dissolving 5 g of sodium lauryl sulfate in 95 g deionized water. This is then sprayed or mopped onto stainless steel in a thin even layer and the liquid allowed to evaporate. Film gels may then be cast onto the treated surface and dried.

### Example 11

A 100 g surfactant solution is made by dissolving 5 g of Polysorbate-80 in 95 g deionized water. This is then sprayed or mopped onto stainless steel in a thin even layer and the liquid allowed to evaporate. Film gels may then be cast onto the treated surface and dried.

### Example 12

In order to test the solutions prepared in Examples 8-11, a separate sheet of stainless steel was wiped down with each surfactant solution and the liquid allowed to evaporate off. This left an evenly coated surface on each piece of stainless steel. Six different film gels which have proven difficult to peel on untreated steel were prepared and cast onto the four is different steel surfaces. The film gels were formulated as follows:

Film Sample 12-1

A 100 g film solution is prepared by dissolving 14.96 g pullulan in 80 g deionized water. To this 2.26 g diglycerol, 2.26 g polyethylene glycol, 0.5 g NaCl, 0.01 g sodium lauryl sulfate, 0.01 g Polysorbate-80, and 0.02 g sodium benzoate are added with stirring. The gel is degassed by either sitting overnight or centrifuging. The gel is then cast onto the four different treated stainless steel sheets and dried to a moisture level of 7.5-9.5%.

Film Sample 12-2

A 100 g film solution is prepared by dissolving 14.96 g pullulan in 80 g deionized water. To this 1 g diglycerol, 1 g polyethylene glycol, 3 g NaCl, 0.01 g sodium lauryl sulfate, 0.01 g Polysorbate-80, and 0.02 g sodium benzoate are added with stirring. The gel is degassed by either sitting overnight or centrifuging. The gel is then cast onto the four different treated stainless steel sheets and dried to a moisture level of 7.5-9.5%.

Film Sample 12-3

A 100 g film solution is prepared by dissolving 14.96 g pullulan in 80 g deionized water. To this 2 g diglycerol, 2 g polyethylene glycol, 1 g KCl, 0.01 g sodium lauryl sulfate, 0.01 g Polysorbate-80, and 0.02 g sodium benzoate are added with stirring. The gel is degassed by either sitting overnight or centrifuging. The gel is then cast onto the four different treated stainless steel sheets and dried to a moisture level of 7.5-9.5%.

Film Sample 12-4

A 100 g film solution is prepared by dissolving 14.96 g pullulan in 80 g deionized water. To this 2 g diglycerol, 2 g polyethylene glycol, 1 g Na₂SO₄, 0.01 g sodium lauryl sulfate, 0.01 g Polysorbate-80, and 0.02 g sodium benzoate are added with stirring. The gel is degassed by either sitting overnight or centrifuging. The gel is then cast onto the four different treated stainless steel sheets and dried to a moisture level of 7.5-9.5%.

Film Sample 12-5

A 100 g film solution is prepared by dissolving 14.96 g pullulan in 80 g deionized water. To this 2.26 g diglycerol, 2.26 g sorbitol, 0.5 g NaCl, 0.01 g sodium lauryl sulfate, 0.01 g Polysorbate-80, and 0.02 g sodium benzoate are added with stirring. The gel is degassed by either sitting overnight or centrifuging. The gel is then cast onto the four different treated stainless steel sheets and dried to a moisture level of 7.5-9.5%.

Film Sample 12-6

A 100 g film solution is prepared by dissolving 14.96 g pullulan in 80 g deionized water. To this 1.5 g diglycerol, 1.5 g sorbitol, 2 g NaCl, 0.01 g sodium lauryl sulfate, 0.01 g Polysorbate-80, and 0.02 g sodium benzoate are added with stirring. The gel is degassed by either sitting overnight or centrifuging. The gel is then cast onto the four different treated stainless steel sheets and dried to a moisture level of 7.5-9.5%.

After drying, the films were all cured in an environmental chamber for 18 hours at 22.5° C. and 45% relative humidity. The films were then peeled off of the stainless steel and ranked as to ease of peel for each film, with 1 being the easiest and 4 the most difficult. The results are shown in Table 5.

TABLE 5

| Film Sample | Example 8 | Example 9 | Example 10 | Example 11 |
|---|---|---|---|---|
| 12-1 | 1 | 2 | 4 | 3 |
| 12-2 | 1 | 1 | 4 | 3 |
| 12-3 | 1 | 2 | 4 | 3 |
| 12-4 | 1 | 2 | 4 | 3 |
| 12-5 | 1 | 2 | 3 | 3 |
| 12-6 | 1 | 2 | 4 | 3 |

The solutions of Examples 8 and 9 allowed for the easiest peeling of the films from the steel substrate. However, the solutions of Examples 10 and 11 also peeled quite easily, and could be used for removal from a steel belt in a commercial setting as well.

### Example 13

Films similar to those shown in Examples 1-3 were made. These films were as follows:

Film 13-1. A 100 g film solution is prepared by dissolving 15.26 g pullulan in 80 g deionized solution is heated to 70° C. for 30 minutes to fully dissolve the gelatin. The solution is continually stirred as it cools to room temperature which keeps the gelatin in solution. The gel is degassed by either sitting overnight or centrifuging. The gels are then cast onto treated stainless steel and dried to a moisture level of 7.5-9.5%. The film can then be easily peeled from the steel for use.

Film 13-2. A 100 g film solution is prepared by dissolving 15.76 g pullulan in 80 g deionized is centrifuging. The gels are then cast onto treated stainless steel and dried to a moisture level of 7.5-9.5%. The film can then be easily peeled from the steel for use.

Film 13-3. A 100 g film solution is prepared by dissolving 15.14 g pullulan in 80 g deionized either sitting overnight or centrifuging. The gels are then cast onto treated stainless steel and dried to a moisture level of 7.5-9.5%. The film can then be easily peeled from the steel for use.

Film 13-4. A 100 g film solution is prepared by dissolving 16.14 g pullulan in 80 g deionized either sitting overnight or centrifuging. The gels are then cast onto treated stainless steel and dried to a moisture level of 7.5-9.5%. The film can then be easily peeled from the steel for use.

Film 13-5. A 100 g film solution is prepared by dissolving 17.14 g pullulan in 80 g deionized sitting overnight or centrifuging. The gels are then cast onto treated stainless steel and dried to a moisture level of 7.5-9.5%. The film can then be easily peeled from the steel for use.

These five films underwent tensile testing on an Instron 5542 tester by method ASTM D882 using Bluehill 2 software. The gage length, film thickness, and strain rate used for each test is given in the table below. Multiple samples were run for each film and the resulting data is calculated by the software. The tensile strength and break elongation percent for each film is determined from these calculations. The results are shown in the following Table 6.

TABLE 6

| | Gage | Strain | Film | Tensile | Break | |
|---|---|---|---|---|---|---|
| | Length | Rate | Thickness | Strength | Elongation | No. of |
| Film | (in) | (mm/min) | (mil) | (kgf/cm²) | (%) | samples |
| 1 | 2 | 500 | 2.5 | 173.2 | 150.3 | 6 |
| 2 | 4 | 50 | 3.8 | 279.3 | 8.4 | 5 |
| 3 | 4 | 50 | 3.7 | 85.3 | 110 | 6 |
| 4 | 4 | 50 | 3.7 | 325.4 | 3.6 | 5 |
| 5 | 4 | 50 | 4.0 | 416.2 | 2.2 | 5 |

As is seen in the above table, both gelatin and salt greatly improve the elongation of pullulan films. Films 13-1 and 13-2, which both contained 21% plasticizer, showed much different elongation values. Without the gelatin (film 2), the film has a break elongation of only 8.4%, while with gelatin, the break elongation increases to 150.3%. Films 13-3, 13-4, and 13-5, which all contain only 14% plasticizer, also show widely different elongations. At this low plasticizer level, little increase in elongation is seen with the addition of only 5% salt. However, when adding 10% salt the break elongation jumps to 110%. The strength was greatly reduced at these high levels of salt. In films with slightly higher levels of traditional plasticizers, the addition of 5% salt also gives much better elongation, as is seen in the previous examples.

### Example 14

A 100 g film solution is prepared by dissolving 15.56 g pullulan in 80 g deionized water. To this solution, 1.20 g glycerin, 3.2 g polyethylene glycol (PEG) 200, 0.01 g sodium lauryl sulfate, 0.01 g Polysorbate-80, and 0.02 g sodium benzoate are added with stirring. Stirring continues at room temperature until the gel is of uniform consistency. The gel is degassed either by sitting overnight or by centrifugation. The gel is then cast onto a stainless steel surface treated with 2% sodium stearoyl lactylate (SSL) dissolved in isopropanol. The cast film is dried to a moisture level of 7.5-9.5%. The film can then be readily peeled from the steel for evaluation and use.

### Example 15

A 100 g film solution is prepared by dissolving 15.36 g pullulan in 79.72 g deionized water. To this solution, 1.20 g glycerin, 3.2 g PEG 200, 0.01 g sodium lauryl sulfate, 0.01 g Polysorbate-80, 0.02 g sodium benzoate, and 0.48 g of a 41.5% paraffin wax emulsion are added with stirring. Stirring continues at room temperature until the gel is of uniform consistency. The gel is degassed either by sitting overnight or by centrifugation. The gel is then cast onto a stainless steel surface treated with 2% SSL dissolved in isopropanol. The cast film is dried to a moisture level of 7.5-9.5%. The film can then be readily peeled from the steel for evaluation and use.

### Example 16

A 100 g film solution is prepared by dissolving 15.16 g pullulan in 79.44 g deionized water. To this solution, 1.20 g glycerin, 3.2 g PEG 200, 0.01 g sodium lauryl sulfate, 0.01 g Polysorbate-80, 0.02 g sodium benzoate, and 0.96 g of a 41.5% paraffin wax emulsion are added with stirring. Stirring continues at room temperature until the gel is of uniform consistency. The gel is degassed either by sitting overnight or by centrifugation. The gel is then cast onto a stainless steel surface treated with 2% SSL dissolved in isopropanol. The cast film is dried to a moisture level of 7.5-9.5%. The film can then be readily peeled from is the steel for evaluation and use.

### Example 17

A 100 g film solution is prepared by dissolving 20.447 g pullulan in 72.190 g deionized water. To this solution, 1.080 g glycerin, 2.160 g PEG 200, 2.700 g sorbitol, 0.054 g of a 10% food grade silicone emulsion, 0.014 g Polysorbate-80, 0.027 g sodium benzoate, and 1.301 g of a 41.5% paraffin wax emulsion are added with stirring. Stirring continues at room temperature until the gel is of uniform consistency. The gel is degassed either by sitting overnight or by centrifugation. The gel is then cast onto a stainless steel surface treated with 2% SSL dissolved in isopropanol. The cast film is dried to a moisture level of 7.5-9.5%. The film can then be readily peeled from the steel for evaluation and use.

### Example 18

A 100 g film solution is prepared by dissolving 15.36 g pullulan in 79.96 g deionized water. To this solution, 1.00 g glycerin, 2.40 g PEG 200, 1.20 g sorbitol, 0.04 g of a 10% food grade silicone emulsion, 0.01 g Polysorbate-80, and 0.02 g sodium benzoate. Stirring continues at room temperature until the gel is of uniform consistency. The gel is degassed either by sitting overnight or by centrifugation. The gel is then cast onto a stainless steel surface treated with 2% SSL dissolved in isopropanol. The cast film is dried to a moisture level of 7.5-9.5%. The film can then be readily peeled from the steel for evaluation and use.

These five formulations (Examples 14-18) are examples of wax-containing pullulan to film formulations and their non-wax analogs.

### Example 19

Polymer thin films can exhibit a tendency to self-adhere, or “block”, under pressure. Films that do not exhibit this tendency can be cast and rolled onto themselves without backing or support. To test self-adhesion in pullulan films, a procedure was developed for a relatively rapid and facile analysis: Three 1″ squares were cut from a cast pullulan film and stacked on a Mylar sheet closed-side to open-side in a staggered configuration. The stacked samples were covered with a second sheet of Mylar to prevent adhesion of film squares to any other surfaces. Five 22″×14″×0.5″ sheets of glass were placed on top of the lot of stacked samples to provide pressure similar to that experienced by film when rolled onto itself. The samples were checked after 24 hours to evaluate the level of surface blocking, or the degree to which the three squares of each sample adhered to one another. Any samples not irreversibly stuck together after 24 hours were reevaluated after a week total elapsed time.

The test results were expressed by assigning a score on a five-point scale:

0—No surface adhesion

1—Film clings, but all three squares peel apart with minimal effort

2—Film clings, but all three squares peel apart with moderate effort

3—Film clings, but all three squares peel apart with significant effort and damage to films

4—All three squares are completely stuck and will not separate

Using this testing methodology, the blocking scores for the films detailed in Examples 14-16 are as follows:

TABLE 7
Blocking Data for Example Films

| Film ID | Wax Content (%) | 1-Day Blocking | 1-Week Blocking |
|---|---|---|---|
| Example 14 | 0 | 2 | 2 |
| Example 15 | 1 | 1 | 2 |
| Example 16 | 2 | 0 | 1 |

It is clear from the data in Table 7 that increasing the wax content in a pullulan film formulation decreases its tendency to self-adhere.

### Example 20

In many commercial packaging operations, film packages are heat-sealed to keep them closed. In order to measure the ability of pullulan films to seal with heat, the following test was performed. To this end, 2″×0.5″ strips of film were sealed together in three different orientations, then pulled apart by hand. Films were sealed open-face-to-open-face (front-to-front), closed-face-to-closed-face (back-to-back), and open-face-to-closed-face is (front-to-back).

The seals were evaluated on a 5-point scale:

0—Film breaks before the seal comes apart

1—Seal partially comes apart before the film breaks

2—Seal pulls completely apart with force; film does not break

3—Seal pulls completely apart with minimal force; film does not break

4—Film will not form a seal at all

Using this test method, the heat seal scores for the films detailed in Examples 14-16 are as follows:

TABLE 8
Heat Seal Data for Example Films

| | Wax Content | | | |
|---|---|---|---|---|
| Film ID | (%) | F-F Seal | B-B Seal | F-B Seal |
| Example 14 | 0 | 1 | 3 | 3 |
| Example 15 | 1 | 0 | 2 | 1 |
| Example 16 | 2 | 0 | 2 | 1 |

The data in Table 8 indicate that the presence of wax in pullulan film formulations increases the ability of the film to form strong seals. Secondly, the results also show that seals involving the closed surface of the film, indicated by “B” above, were not as good as seals made from open surface to open surface. In Example 14, the only difference between the closed and open surfaces of the film is the presence of SSL on the closed surface. SSL, therefore, appears to be responsible for decreased seal strength when treated surfaces are involved. That decreased seal strength occurs only when the closed surface is involved is an indication that the SSL is immiscible with the aqueous casting gel and remains localized on the closed surface.

### Example 21

In commercial packaging applications, films are run through machines in such a manner that the film must exhibit some level of slip for the packaging to proceed correctly. The degree of slip is expressed as the coefficient of friction.

This test is run on an Instron 5542 using a coefficient of friction attachment (Model #2810-005). The test follows ASTM D1894, and utilizes Bluehill 2 software for method control and analysis. By this method, a sled (2.5 in², 200 g) is wrapped in the film to be tested, and placed onto the testing table. The testing table is covered with the desired test material. The table is covered with film to test the slip of film on film, and it is also covered with a stainless steel sheet (4.5″×15″) for testing the slip of the film on steel. The sled is then pulled along the table by a tow line at a rate of 150 mm/min. The tow line is attached to a load cell on the Instron via a hook assembly, which measures the force needed to pull the sled.

For each complete test, three runs are performed and their results averaged for the final calculation. The coefficient of friction is calculated by dividing the force necessary to pull the sled by the weight of the sled. The static coefficient of friction is the amount of force necessary to start the sled moving, and is calculated using the maximum force from the first peak. The dynamic coefficient of friction is defined as the force necessary to keep the sled moving and is calculated by averaging the force over the next 10 inches of testing, and dividing it by the sled weight. All calculations are carried out by the Bluehill 2 software.

A summary of the coefficient of friction test results for a wax-containing pullulan film and a petrochemical-based film in use by commercial packaging operations is as follows:

TABLE 9
Coefficient of Friction Data for Example Films

| | | | | SD | SD |
|---|---|---|---|---|---|
| | | Dynamic | Static | Dynamic | Static |
| Film ID | Orientation | CoF | CoF | COF | COF |
| Example 17 | B-B | 0.1361 | 0.1889 | 0.0026 | 0.0039 |
| Example 17 | F-B | 0.1532 | 0.3257 | 0.0036 | 0.0300 |
| Example 17 | F-F | 0.2100 | 0.5284 | 0.0179 | 0.0403 |
| Example 17 | F-Steel | 0.1663 | 0.2697 | 0.0283 | 0.0212 |
| Example 17 | B-Steel | 0.1580 | 0.2085 | 0.0042 | 0.0097 |
| Example 18 | B-B | 0.1646 | 0.4592 | 0.0146 | 0.0504 |
| Example 18 | F-B | 0.2458 | 0.8133 | 0.0168 | 0.3206 |
| Example 18 | F-F | 0.7436 | 3.8825 | 0.1045 | 0.2981 |
| Example 18 | F-Steel | 0.3268 | 0.8638 | 0.0136 | 0.1265 |
| Example 18 | B-Steel | 0.1922 | 0.3691 | 0.0128 | 0.1020 |
| Commercial | B-B | 0.1678 | 0.2308 | 0.0098 | 0.0031 |
| Film | | | | | |
| Commercial | F-B | 0.1554 | 0.2216 | 0.0070 | 0.0216 |
| Film | | | | | |
| Commercial | F-F | 0.1341 | 0.1828 | 0.0014 | 0.0109 |
| Film | | | | | |
| Commercial | F-Steel | 0.2293 | 0.2657 | 0.0095 | 0.0217 |
| Film | | | | | |
| Commercial | B-Steel | 0.2291 | 0.3067 | 0.0420 | 0.0845 |
| Film | | | | | |

The data given in Table 9 indicate that pullulan film without wax has higher coefficient of friction values, and therefore much less slip, than either the wax-containing film or the film obtained from a commercial packer. Second, even though the wax-free film has poor slip in all tests involving the front surface, tests involving only the back surface have similar CoF values to corresponding tests on the wax-containing film. This suggests that the SSL is responsible for the slip properties of the rear face of the film. Third, the CoF values of the wax-containing film are similar to, and in most cases better than, those associated with film presently used by commercial packers.

### Example 22

Visible evidence for the three layered structure of a film produced as described above was obtained using an Olympic BX-51 optical microscope. Film surfaces were viewed at 40× magnification under reflected, partially cross-polarized, and fully cross-polarized light. The surface of a pullulan film that did not contain wax and was not cast on a surface treated with SSL, when viewed under both reflected and slightly cross-polarized reflected light, was smooth and relatively featureless. There was no evidence of any crystalline substance on this film surface.

The open, or uppermost, surface of a pullulan film containing wax and cast on a surface treated with SSL, had coarse-grained wax domains that were clearly visible when viewed under reflected, fully cross-polarized light. The absence of fine SSL crystals on this surface was also noted.

The closed surface of the same film described in the previous paragraph was viewed again under similar lighting conditions. There was no visible evidence of coarse wax domains on this surface of the film, but it was possible to see very fine crystals of SSL. From these observations, it appears that SSL remains localized on the closed surface of the film, while the wax particles congregate on the open surface of the film, leaving a simple plasticized pullulan layer between. This tri-layer structure was achieved by a single coating on a treated surface, but it could also be achieved by a multiple-pass coating, as the is processing conditions and projected application require.

### Example 23

Six different water-soluble proteins were examined for their use in films. These films were all made by dissolving 18.575 g pullulan, 1.875 g glycerol, 3.625 g sorbitol, 0.25 g propylene glycol, 0.025 g sodium lauryl sulfate, 0.025 g sodium benzoate, and 0.625 g of one of the following water-soluble proteins in 75 g of water:

a) Gelatin 1385P from Nitta Gelatin

b) Instagel from PB Gelatins

c) Promois WJ, hydrolyzed pea protein from Seiwa Kasei Co., LTD.

d) Promois WS, hydrolyzed soy protein from Seiwa Kasei Co., LTD.

e) Promois SIG, hydrolyzed sesame protein from Seiwa Kasei Co., LTD.

f) Promois Hydromilk, hydrolyzed milk protein from Seiwa Kasei Co., LTD.

The resultant gels were de-gassed, cast onto stainless steel and dried in an environmental chamber at 65° C., and a relative humidity of 25% for one hour and 15 minutes. At that time the chamber was reset to 22.5° C. and a relative humidity of 45% for curing overnight. The films were then removed from the steel and tested. All were tested for tensile strength and elongation by the probe method on an Instron device, and moisture by Karl Fischer oven-method analysis.

A previous example shows that gelatin works to improve elongation without significantly decreasing the tensile strength. These other proteins were examined to determine if other water-soluble proteins would have the same types of effects on the mechanical properties. The results are shown in Table 10 below.

TABLE 10

| | Tensile | | |
|---|---|---|---|
| | Strength | | |
| Protein | Kg/sqcm | Elongation % | Moisture % |
| a | 219.4 | 34.0 | 6.6 |
| b | 246.6 | 27.1 | 6.8 |
| c | 174.5 | 7.7 | 6.9 |
| d | 167.9 | 7.7 | 5.9 |
| e | 176.1 | 10.1 | 5.9 |
| f | 202.7 | 13.6 | 6.0 |

None of the proteins tested worked as well as gelatin. They all reduced elongation, and most of them reduced the tensile strength as well. However, these proteins were successfully added to the gels, without the gels solidifying.

Edible Film Formulations Including Various Salts

Previous examples show that the addition of table salt, NaCl, significantly improves elongation in pullulan films. Other salts were tested at various concentration levels to determine if they have the same effect on pullulan films. The films in examples 24-28 were made as described and then tested. Tests included mechanical tests by the probe method on an Instron, Karl Fischer moisture analysis, and dissolution testing.

A test method named “quick dissolution analysis” was developed to quickly determine the dissolution properties of pullulan films. The method simply uses a stopwatch, stir plate, beaker, stir bar, and thermometer. For the cold-water test, the temperature of the water used is within the range of 5-15° C., and for the hot water test it is within the range of 65-75° C. A beaker of either hot or cold water is placed on a stir plate and stirred at a moderate pace. The temperature is measured with a thermometer and recorded. A piece of film, approximately one inch square in size, is cut and dropped into the water. The timer is started as soon as the film is in the water. The time at which the film is completely dissolved is recorded. The apparatus is cleaned and fresh water obtained before starting the next test.

### Example 24

A film that contains no salt was first made to use as a control. This film was made by dissolving 19.7125 g pullulan, 0.75 g glycerol, 2.5 g sorbitol, 2 g polyethylene glycol (200 MW), 0.0125 g sodium lauryl sulfate, and 0.025 g sodium benzoate in 75 g of water. The gel was cast onto stainless steel and dried in an environmental chamber at 65° C., and a relative humidity of 25% for one hour and 15 minutes. At that time the chamber was reset to 22.5° C. and a relative humidity of 45% for curing overnight. The film was then removed from the steel and tested.

### Example 25

Three films that contain 1.25% (dsb) of three different salts were made. These films is were made by dissolving 19.4 g pullulan, 0.75 g glycerol, 2.5 g sorbitol, 2 g polyethylene glycol (200 MW), 0.0125 g sodium lauryl sulfate, 0.025 g sodium benzoate, and 0.3125 g of one of the following salts in 75 g of water.

NaCl

MgCl₂

CaCl₂

The gels were all cast onto stainless steel and dried in an environmental chamber at 65° C., and a relative humidity of 25% for one hour and 15 minutes. At that time the chamber was reset to 22.5° C. and a relative humidity of 45% for curing overnight. The films were then removed from the steel and tested.

### Example 26

Six films that contain 2.5% of six different salts were made. These films were made by dissolving 19.0875 g pullulan, 0.75 g glycerol, 2.5 g sorbitol, 2 g polyethylene glycol (200 MW), 0.0125 g sodium lauryl sulfate, 0.025 g sodium benzoate, and 0.625 g of one of the following salts in 75 g of water.

NaCl

MgCl₂

CaCl₂

KCl

LiCl

Na₂SO₄

The gels were all cast onto stainless steel and dried in an environmental chamber at 65° C., and a relative humidity of 25% for one hour and 15 minutes. At that time the chamber was reset to 22.5° C. and a relative humidity of 45% for curing overnight. The films were then removed from the steel and tested.

### Example 27

Four films which contain 5% of four different salts were made. These films were made by dissolving 18.4625 g pullulan, 0.75 g glycerol, 2.5 g sorbitol, 2 g polyethylene glycol (200 MW), 0.0125 g sodium lauryl sulfate, 0.025 g sodium benzoate, and 1.25 g of one of the following salts in 75 g of water.

NaCl

KCl

LiCl

Na₂SO₄

The gels were all cast onto stainless steel and dried in an environmental chamber at 65° C., and a relative humidity of 25% for one hour and 15 minutes. At that time the chamber was reset to 22.5° C. and a relative humidity of 45% for curing overnight. The films were then removed from the steel and tested.

### Example 28

Films containing combinations of the salts NaCl and MgCl₂ in different proportions were prepared. These films were made as follows:

a) This film was made by dissolving 19.0875 g pullulan, 0.75 g glycerol, 2.5 g sorbitol, 2 g polyethylene glycol (200 MW), 0.0125 g sodium lauryl sulfate, 0.025 g sodium benzoate, 0.3125 g NaCl, and 0.3125 g MgCl₂ in 75 g of water. The gel was cast onto stainless steel and dried in an environmental chamber at 65° C., and a relative humidity of 25% for one hour and 15 minutes. At that time the chamber was reset to 22.5° C. and a relative humidity of 45% for curing overnight. The films were then removed from the steel and tested.

b) This film was made by dissolving 18.775 g pullulan, 0.75 g glycerol, 2.5 g sorbitol, 2 g polyethylene glycol (200 MW), 0.0125 g sodium lauryl sulfate, 0.025 g sodium benzoate, 0.625 g NaCl, and 0.3125 g MgCl₂ in 75 g of water. The gel was cast onto stainless steel and dried in an environmental chamber at 65° C., and a relative humidity of 25% for one hour and 15 minutes. At that time the chamber was reset to 22.5° C. and a relative humidity of 45% for curing overnight. The films were then removed from the steel and tested. A summary of results from the preceding examples is shown below:

TABLE 11

| | | | Tensile | | | | |
|---|---|---|---|---|---|---|---|
| | | % Salt | Strength | | | Cold Water | Hot Water |
| Example | Salt | dsb | Kg/sqcm | Elongation % | Moisture % | Dissolutions | Dissolutions |
| 24 | none | | 207.1 | 35.1 | 8.4 | 91 | 38 |
| 25a | NaCl | 1.25% | 191.6 | 119.5 | 9.9 | 40 | 33 |
| 25b | MgCl₂ | 1.25% | 254.8 | 107.3 | 8.8 | 38 | 13 |
| 25c | CaCl₂ | 1.25% | 187.3 | 67.1 | 10.0 | 36 | 20 |
| 26a | NaCl | 2.50% | 283.5 | 131.9 | 9.1 | 42 | 39 |
| 26b | MgCl₂ | 2.50% | 215.5 | 177.1 | 8.8 | 53 | 39 |
| 26c | CaCl₂ | 2.50% | 192.5 | 30.0 | 8.9 | 81 | 42 |
| 26d | KCl | 2.50% | 258.6 | 67.1 | 8.1 | 176 | 35 |
| 26e | LiCl | 2.50% | 260.2 | 73.3 | 8.7 | 43 | 28 |
| 26f | Na₂SO₄ | 2.50% | 283.4 | 49.2 | 7.9 | 48 | 12 |
| 27a | NaCl | 5.00% | 252.6 | 110.0 | 8.3 | 45 | 24 |
| 27b | KCl | 5.00% | 276.5 | 111.3 | 7.5 | 60 | 27 |
| 27c | LiCl | 5.00% | 231.3 | 252.9 | 8.9 | 49 | 18 |
| 27d | Na₂SO₄ | 5.00% | 161.3 | 20.8 | 7.8 | 86 | 8 |

Note: all film thicknesses were in the range of 2.1 to 3.1 mils

In Table 11, the examples are organized by salt content. In most cases, the addition of salt at all levels improves elongation while maintaining strength. The only exceptions to this are for films containing higher levels of calcium chloride and sodium sulfate. It is also evident that the addition of all salts improves cold-water dissolution times. The one instance to of KCl being higher is likely due to clumping of the sample in the water, which leads to longer dissolution times. It is also important to note that a few of the salt films have significantly higher levels of moisture. The salt tends to hold water and act as a humectant, which helps to improve the elongation of the films.

It was found that incorporating higher levels of salt into the films does not always translate into higher levels of elongation. With some salts, higher levels tend to lead to brittleness within the films. Because of this, it is useful to optimize the amount of salt added based on which salt is being added. Each salt has its own optimum level that can be determined with routine experimentation. For NaCl, this level is about 2.5%. It should also be noted that the inclusion of increased levels of salt does not significantly affect the dissolution time within a salt. The inclusion of salt does improve dissolution times; however, it is not proportional to the amount of salt added. Calcium chloride and sodium sulfate are the two salts of those tested with the smallest effect on mechanical properties. Lithium chloride provided the greatest effect on mechanical properties.

Sodium chloride and magnesium chloride seem to give the most consistent results and are commonly used in foods. In order to determine the best possible film, these two were combined to see if a mixture of the two would give an even better film. As is shown in the data in Table 12, they do improve elongation. However, the addition of more sodium chloride reduces strength, which leads to brittleness in the films. Film 28a was a good film with good feel, no tackiness, and little brittleness at low moisture conditions. It has been determined that a film which contains both sodium chloride and magnesium chloride at a concentration of 1.25% appears to give the best results of all of the salt-containing films tested thus far. However, other salts by themselves give good results as well.

TABLE 12

| | | | | | Tensile | | | | |
|---|---|---|---|---|---|---|---|---|---|
| | | % Salt | | % Salt | Strength | | | Cold Water | Hot Water |
| Example | Salt | dsb | Salt | dsb | Kg/sqcm | Elongation % | Moisture % | Dissolutions | Dissolutions |
| 24 | none | | | | 207.1 | 35.1 | 8.4 | 91 | 38 |
| 28a | NaCl | 1.25% | MgCl₂ | 1.25% | 222.9 | 127.7 | 10.7 | 51 | 58 |
| 28b | NaCl | 2.50% | MgCl₂ | 1.25% | 164.1 | 138.9 | 10.6 | 46 | 18 |

### Example 29

A pullulan film was cast and dried on a sheet of 2 mil polyester film. The dried pullulan film layer was about 4 mil in thickness and was allowed to remain attached to the polyester substrate. Two 4.5-inch wide rolls of this bilayered construction were loaded onto a Transwrap vertical form-fill-seal packaging machine such that the pullulan layer was on the inside (in contact with the fill material) and the polyester layer was on the outside. The heat-sealing jaws of the machine were set to a constant temperature of 125° C. The machine was actuated and the bilayered film construction was successfully formed into 4.5-inch by 5.5-inch pouches containing food grade fill material. Sealing of the pullulan layer to form the food pouch was successfully performed by heating through the protective polyester layer. The protective polyester film layer remained adhered to the finished pouches, but could be easily peeled off of the pouches before using the edible pouch and its contents for food preparation.

The preceding description of certain embodiments of the invention is not intended to be an exhaustive list of all possible embodiments. Persons skilled in this field will appreciate that modifications could be made to the specific embodiments described herein which would be within the scope of the following claims.

1.-61. (canceled)

62. An edible film, comprising:
a first layer comprising a major amount of at least one food grade wax;
a second layer comprising a major amount of pullulan and further comprising at least one plasticizer; and
a third layer comprising at least one surfactant that is substantially immiscible with aqueous pullulan compositions but which adheres to pullulan surfaces, wherein the at least one surfactant is at least partially crystalline.

63. The film of claim 62, wherein the at least one surfactant comprises sodium stearoyl lactylate.

64. The film of claim 62, wherein the second layer further comprises particles of food grade wax.

65. The film of claim 62, wherein the second layer comprises about 35-80% by weight pullulan on a dry solids basis.

66. The film of claim 62, wherein the plasticizer in the second layer comprises at least two of glycerol, propylene glycol, sorbitol, and polyethylene glycol.

67. The film of claim 62, wherein the second layer comprises about 0.5-22.5% by weight gelatin on a dry solids basis.

68. The film of claim 62, wherein the second layer further comprises starch, a starch derivative, alginate, xanthan gum, collagen, polydextrose, or a combination of two or more thereof.

69. The film of claim 62, wherein the second layer comprises glycerol, propylene glycol, and sorbitol.

70. The film of claim 69, wherein the second layer comprises about 1-30% glycerol, about 1-30% propylene glycol, and about 1-30% by weight sorbitol on a dry solids basis.

71. The film of claim 62, wherein the second layer further comprises at least one salt.

72. The film of claim 71, wherein the at least one salt comprises NaCl, MgCl₂, or a combination thereof.

73. The film of claim 71, wherein the at least one salt is present in the second layer at a concentration of about 0.3-15% by weight on a dry solids basis.

74. The film of claim 62, wherein the at least one surfactant is about 0.001-0.1% by weight of the film.

75. An edible article, comprising a food product and edible film according to any of claims 62-74 that encloses the food product.

76. The edible article of claim 75, wherein the food product is selected from powdered beverage mix, candy, powdered cheese product, powdered egg product, dry soup and casserole mixes, food dyes and spices.

77. A method for making an edible film, comprising:
applying to a substrate a solution or suspension that comprises a major amount of at least one surfactant that is substantially immiscible with aqueous pullulan compositions;
drying or concentrating the solution or suspension to form a first layer that comprises a major amount of dried surfactant that is at least partially crystalline;
applying to the dried surfactant layer an aqueous solution or suspension that comprises pullulan, at least one plasticizer, and at least one food grade wax; and
drying or concentrating the aqueous solution or suspension, whereby a second layer and a third layer are formed, the second layer being on top of the first layer and the third layer being on top of the second layer, wherein the second layer comprises plasticizer and a major amount of pullulan and the third layer comprises a major amount of food grade wax.

78. The method of claim 77, wherein the at least one surfactant comprises sodium stearoyl lactylate.

79. The method of claim 77, wherein the second layer further comprises particles of food grade wax.

80. The method of claim 77, wherein the second layer comprises about 35-80% by weight pullulan on a dry solids basis.

81. The method of claim 77, wherein the plasticizer in the second layer comprises at least two of glycerol, propylene glycol, sorbitol, and polyethylene glycol.

82. The method of claim 77, wherein the second layer comprises about 0.5-22.5% by weight gelatin on a dry solids basis.

83. The method of claim 77, wherein the second layer further comprises starch, a starch derivative, alginate, xanthan gum, collagen, polydextrose, or a combination of two or more thereof.

84. The method of claim 77, wherein the second layer comprises glycerol, propylene glycol, and sorbitol.

85. The method of claim 84, wherein the second layer comprises about 1-30% glycerol, about 1-30% propylene glycol, and about 1-30% by weight sorbitol on a dry solids basis.

86. The method of claim 77, wherein the second layer further comprises at least one salt.

87. The method of claim 86, wherein the at least one salt comprises NaCl, MgCl₂, or a combination thereof.

88. The method of claim 86, wherein the at least one salt is present in the second layer at a concentration of about 0.3-15% by weight on a dry solids basis.

89. An edible film, comprising;
a major amount of pullulan on a dry solids basis;
at least one salt; and
at least one plasticizer.

90. The film of claim 89, wherein the film comprises at least two salts.

91. The film of claim 90, wherein the at least two salts comprise NaCl and MgCl₂.

92. The film of claim 89, wherein the at least one salt is present in the film at a concentration of about 0.3-15% by weight on a dry solids basis.

93. The film of claim 89, wherein the at least one plasticizer is selected from glycerol, propylene glycol, sorbitol, polyethylene glycol, and combinations thereof.

94. The film of claim 93, wherein the film comprises at least two of glycerol, propylene glycol, sorbitol, and polyethylene glycol.

95. The film of claim 89, wherein the film comprises about 35-80% by weight pullulan on a dry solids basis.

96. The film of claim 89, wherein the film comprises about 0.5-22.5% by weight gelatin on a dry solids basis.

97. The film of claim 89, further comprising at least one internal film release agent.

98. The film of claim 97, wherein the at least one internal film release agent comprises polyoxyethylene sorbitan monooleate, sodium lauryl sulfate, or a combination thereof.

99. An edible article, comprising a food product and edible film according to any of claims 89-98 that encloses the food product.

100. A film structure comprising an edible film adhered to a peelable, flexible substrate, wherein the edible film comprises:
a major amount of pullulan on a dry solids basis; and
at least one plasticizer.

101. The film structure of claim 100, wherein the flexible substrate comprises a polymeric film.

102. The film structure of claim 101, wherein the flexible substrate comprises a polyester film.

103. The film structure of claim 100, wherein the edible film comprises at least one salt.

104. The film structure of claim 103, wherein the edible film comprises at least two salts.

105. The film structure of claim 104, wherein the at least two salts comprise NaCl and MgCl₂.

106. The film structure of claim 103, wherein the at least one salt is present in the edible film at a concentration of about 0.3-15% by weight on a dry solids basis.

107. The film structure of claim 100, wherein the at least one plasticizer is selected from glycerol, propylene glycol, sorbitol, polyethylene glycol, and combinations thereof.

108. The film structure of claim 107, wherein the film comprises at least two of glycerol, propylene glycol, sorbitol, and polyethylene glycol.

109. The film structure of claim 100, wherein the edible film comprises about 35-80% by weight pullulan on a dry solids basis.

110. The film structure of claim 100, wherein the edible film comprises about 0.5-22.5% by weight gelatin on a dry solids basis.

111. The film structure of claim 100, wherein the edible film further comprises at least one internal film release agent.

112. The film structure of claim 111, wherein the at least one internal film release agent comprises polyoxyethylene sorbitan monooleate, sodium lauryl sulfate, or a combination thereof.

113. The film structure of claim 111, wherein the flexible substrate comprises a biodegradable polymeric film.

114. The film structure of claim 113, wherein the biodegradable polymeric film comprises polylactic acid, polyglycolic acid, copolymer of lactic and glycolic acid, or a mixture of two or more thereof.
